(19) United States
(12) Patent Application Publication
(10) Pub. No.: US 2009/0100955 A1
(43) Pub. Date: Apr. 23, 2009

(54) METHOD AND APPARATUS FOR A LEVER CONTROL

(75) Inventors: John Herrick, Sunriver, OR (US); Kendrick Seelye, Dundee, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WILLIAMS CONTROLS, INC., Portland, OR (US)

(21) Appl. No.: 11/876,594

(22) Filed: Oct. 22, 2007

(51) Int. Cl. G05G 1/04

(52) U.S. Cl. 74/491

(57) ABSTRACT

Embodiments of the present invention provide a rotary based hand control that provides hysteresis to an operator. Other embodiments may be described and claimed.

### TECHNICAL FIELD

Embodiments of the present invention relate to the field of hand controls for various apparatus, and more particularly, to hand controls that include hysteresis.

### BACKGROUND

General hand controls for various types of machinery often require some type of drag or hysteresis. The purpose of such drag is to give the operator some feed back (kinesthetics) and to help insure that the control position remains constant despite being influenced by external factors, such as vibration or light contact. In other representative designs of such devices, compression packs (disks and coil springs) are typically employed to provide a clamping force on an axis of rotation for the control. However, such devices generally require adjustment and setting at the time of assembly and consist of multiple parts, such as, for example, washers and rub plates under compression that are clamped to a handle of the control.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a back elevation view of a hand control in accordance with various embodiments of the present invention;

FIG. 2 is a side elevation view of a hand control in accordance with various embodiments of the present invention;

FIG. 3 is a front elevation view of a hand control, with a hand lever illustrated in the other figures removed for clarity, in accordance with various embodiments of the present invention; and

FIG. 4 is an exploded view of a hand control in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide a rotary based hand control that provides hysteresis to an operator.

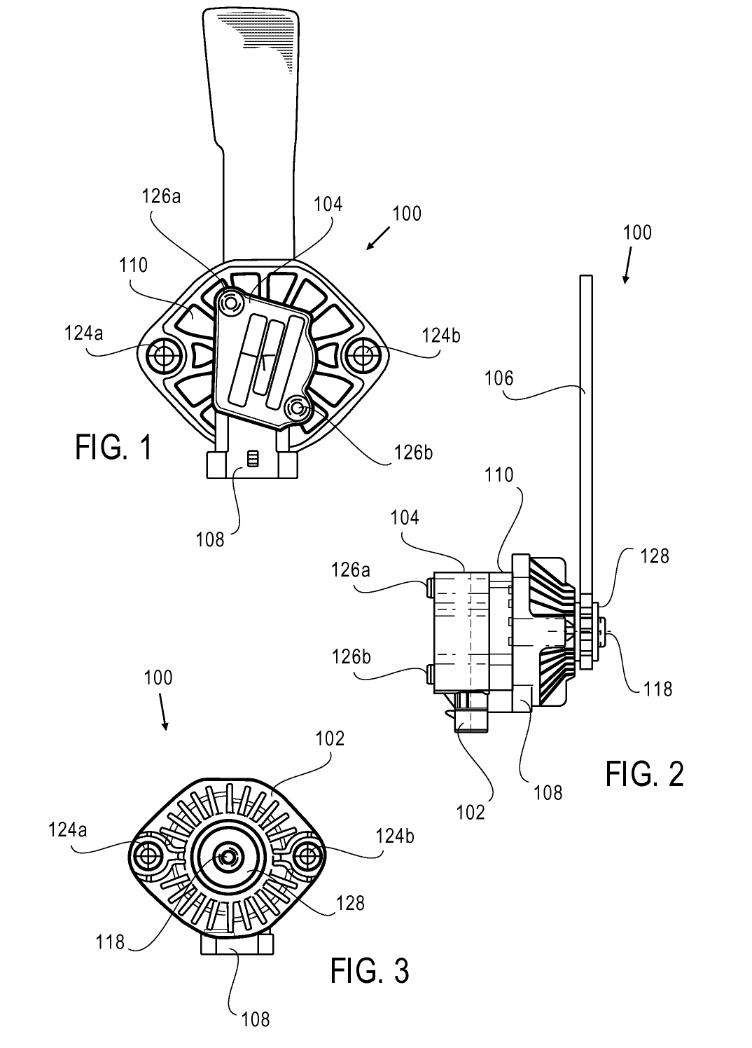

Referring to FIGS. 1-3, a hand control 100 in accordance with various embodiments of the present invention is illustrated. The hand control may include a body 102, a position sensor 104 and a lever 106 arranged as depicted. The sensor 104 includes an appropriate electrical coupling 108 known in the art for coupling the hand control to a control system (not illustrated). For example, sensor 104 may be a contact or non-contact type position sensor adapted to sense the lever position and generate a control based signal.

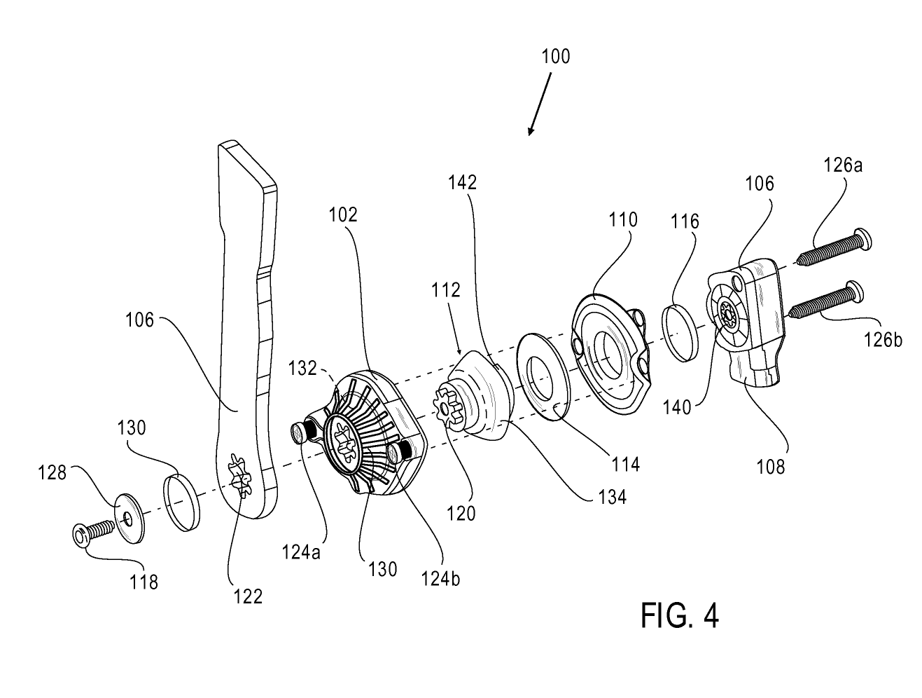

In one embodiment, as illustrated in FIGS. 1 and 2, body 102 may include a cover plate 110 coupled thereto. Additionally, a rotor 112 and one or more spring elements 114 (illustrated in FIG. 4) may be arranged within body 102. In one embodiment, spring element 114 may consist of a Belleville spring. In other embodiments, a different type of spring element(s) may be used in order to vary the hysteresis response.

In accordance with various embodiments, rotor 112 is positioned adjacent to the spring element and adapted to rest within body 102. A cover seal 116 may be provided between cover 110 and sensor 104. As may be seen in FIGS. 2-4, a fastener 118, such as, for example, a screw may be used to couple lever 106 to rotor 112.

In accordance with various embodiments, rotor 112 may be coupled to lever 106 via a cooperative mating structure, such that manipulation of lever 106 causes manipulation of rotor 112. As an example, in FIG. 4, the cooperative mating structure may be a star shaped gear 120 on rotor 112 that cooperates with a star shaped opening 122 defined within lever 106. Additionally, rotor 112 may be coupled to sensor 104 via a cooperating mating structure 140, 142. For example, the cooperative mating structure may also be a star shaped arrangement similar to that described for rotor 112 and lever 106. It may be appreciated that a number of types of cooperative mating structures known in the art may be used to couple the rotor to the lever and/or sensor.

Cover plate 110 may be coupled to body 102 via a suitable means such as, for example, retainers 124a and 124b. Additionally, sensor 104 may be coupled to cover 110 and/or body 102 via suitable means such as, for example, screws 126a and 126b. As previously mentioned, lever 106 may be coupled to rotor 112 via a suitable coupling device such as, for example, screw 118. In the exemplary embodiment illustrated, a washer 128 and a seal 130 may be placed between lever 106 and screw 118.

In accordance with various embodiments, as may be seen in FIGS. 2 and 4, body 102 includes a surface 130 that defines a substantially conical-shaped cavity 132. Additionally, in accordance with various embodiments, as may be seen in FIG. 4, rotor 112 includes a portion 134 having a substantially conical shape. Thus, when control 100 is in an operational assembly, substantially conical-shaped portion 134 is placed within substantially conical-shaped cavity 132. Spring element 114 biases substantially conical-shaped portion 134 such that there may be a slight clearance between substantially conical-shaped portion 134 and surface 130, or such that substantially conical portion 134 engages surface 130.

Thus, during operation of hand control 100, rotation of rotor 112 causes substantially conical-shaped portion 134 to move within substantially conical-shaped cavity 132. As lever 106 rotates rotor 112, the pressure exerted by spring element 114 increases against rotor 112, thus causing substantially conical-shaped portion 134 to engage surface 130 with an increasing amount of force and thereby provide increased resistance to further rotation of rotor 112. This engagement may provide tactile “feedback” to the operator as lever 106 is being moved. The amount of feedback may be influenced by factors, such as, for example, the angle of substantially conical-shaped portion 134 and substantially conical-shaped cavity 132 and the axial spring force provided by spring element 114. The material of one or more of substantially conical-shaped portion and body 102 (at least surface 130) defining substantially conical-shaped cavity 132 may also influence the amount of tactile feedback provided to the operator due to, for example, the coefficient of friction of the material(s) and the glass transition temperature of the material(s).

Accordingly, in operation, lever 106 may be used to control at least one parameter of a device, such as, for example, an engine. In one embodiment, by moving lever 106, substantially conical-shaped portion 134 and substantially conical-shaped cavity 132 may be caused to move or rotate relative to one another. The engagement between substantially conical-shaped portion 134 and surface 130 may cause rotor 112 to hold a desired position, until lever 106 is further manipulated by an operator. Such movement may also cause the sensor to sense the amount of rotation of the rotor due to the cooperative mating structure coupling it to the rotor. The sensor then provides this information to a control system. The control system uses this to control at least one parameter. As an example, this information may be used to control the speed of an engine. Further, lever 106 may be any one of a variety of input controls, including, but not limited to, hand controls, foot controls and the like.

In accordance with various embodiments, engagement between substantially conical-shaped portion 134 of rotor 112 and surface 130 may cause enough holding resistance to resist further advancement or reverse movement of lever 106, even in light of external influences, such as vibration, inadvertent contact, and the like.

As noted, engagement between substantially conical-shaped portion 134 of rotor 112 and surface 130 helps generate feedback felt by an operator that is applying force to lever 106. This also helps to ensure a constant application of force to lever 106 despite external vibrations and other factors that may be occurring.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A control apparatus comprising:
a housing including a surface defining a substantially conical-shaped cavity;
a rotor including a substantially conical-shaped portion located proximal to the surface and adapted to engage the surface;
at least one spring element within the housing adapted to bias the substantially conical-shaped portion to engage the surface; and
a lever coupled to the rotor and adapted to move the rotor relative to the surface.

2. The control apparatus of claim 1, further comprising a sensor coupled to the rotor that senses movement of the rotor to control operation of a device.

3. The control apparatus of claim 1, wherein the control apparatus comprises multiple spring elements arranged axially within the housing.

4. The control apparatus of claim 1, wherein the control apparatus comprises one spring element adjacent the rotor and aligned axially with the rotor.

5. The control apparatus of claim 4, wherein the spring element is a Belleville spring.

6. A method comprising:
engaging a substantially conical-shaped portion of a pivot with a surface of a housing defining a substantially conical-shaped cavity within the housing;
moving the pivot relative to the surface;
sensing movement of the pivot with a sensor operatively coupled to the pivot; and
translating sensed movement of the pivot to control at least one parameter of an apparatus.

7. The method of claim 6, wherein moving the pivot comprises moving a lever operatively coupled to the pivot.

8. The method of claim 6, further comprising biasing the substantially conical portion against the surface with at least one spring element.

9. The method of claim 8, further comprising increasing an amount of biasing force by the at least one spring element as the pivot moves.

10. The method of claim 9, wherein the apparatus comprises an engine.

11. A hand control for controlling at least one parameter of an engine's operation, the control comprising:
a housing including a surface defining a substantially conical-shaped cavity;
a rotor including a substantially conical-shaped portion located proximal to the surface and adapted to engage the surface;
at least one spring element within the housing adapted to bias the substantially conical-shaped portion to engage the surface;
a lever coupled to the rotor and adapted to move the rotor relative to the surface; and
a sensor coupled to the rotor that senses movement of the rotor to control the at least one parameter of the engine's operation.

12. The hand control of claim 11, wherein the hand control comprises multiple spring elements arranged axially within the housing.

13. The hand control of claim 11, wherein the hand control comprises one spring element adjacent the rotor and aligned axially with the rotor.

14. The hand control of claim 13, wherein the spring element is a Belleville spring.
